(19) United States
(12) Patent Application Publication
(10) Pub. No.: US 2007/0258075 A1
(43) Pub. Date: Nov. 8, 2007

(54) Apparatus for processing a semiconductor wafer and method of forming the same

(75) Inventors: Ki-Chul Kim, Suwon-si (KR); Hong-Jae Shin, Seoul (KR); Nae-In Lee, Seoul (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/790,175

(22) Filed: Apr. 24, 2007

(30) Foreign Application Priority Data
May 3, 2006 (KR) 10-2006-0040123

(51) Int. Cl. G03B 27/52

(52) U.S. Cl. 355/55

(57) ABSTRACT

A semiconductor wafer processing apparatus may include a chuck and/or a focus ring. The chuck may be configured to hold a wafer. The focus ring may be disposed surrounding a rim of the chuck. The focus ring may include a first section formed of a first material and a second section formed of a second material. The first material and the second material may have different conductivities. A method of forming a semiconductor wafer processing apparatus may include forming a first section of a focus ring from a first material, forming a second section of the focus ring from a second material having a different conductivity than the first material, combining the first and second sections to form a focus ring, and/or arranging the focus ring so as to surround a chuck.

### PRIORITY STATEMENT

This application claims priority under 35 U.S.C. § 119 to Korean Patent Application No. 2006-40123, filed on May 3, 2006, in the Korean Patent Office, the entire contents of which are incorporated herein by reference.

### BACKGROUND

Semiconductor device manufacturing may include various processes, for example, oxidation, masking, photoresist coating, etching, diffusion, stacking, etc. . . . Semiconductor device manufacturing may also include various auxiliary processes, for example, washing, drying, inspection, etc. . . . The etching process, for example, may be used to form patterns on a wafer, and may be classified as dry etching or wet etching.

The dry etching process may be performed to remove an exposed portion of a photoresist pattern, for example, one formed on a wafer through a photolithography process. In the dry etching process, an oscillating voltage may be applied to upper and lower electrodes spaced apart by a given distance within a hermetically sealed etching space to form an electrical field. When a reactive gas is fed into the hermetically sealed space, the electric field may be used to transform the gas into a plasma. The ions in the plasma may be used to etch the wafer.

FIG. 1 is a graph illustrating example etch rates at various regions in a wafer for different example focus ring materials.

Referring to FIG. 1, when using a focus ring formed of a material with a relatively low conductivity, or an insulating material, illustrated by quartz, for example, the etch rate may be higher at the edges than at the center of the wafer. Thus, a line width may be non-uniform and depend on the region of the wafer. For example, use of a focus ring formed of a material with low conductivity may lower the etch uniformity between the center and the edge of the wafer. Since this may result in chip defects at the edge or the center of the wafer, this may undesirably affect the yield rate.

When using a focus ring with high conductivity, illustrated by glass carbon in FIG. 1, for example, the etch uniformity between the center and the edges of the wafer may be improved. However, the accompanied decrease in etch rate may lead to a decrease in the throughput, which may be increasingly problematic when using larger caliber wafers.

### SUMMARY

Example embodiments are directed to an apparatus and method of processing a semiconductor wafer, for example, a semiconductor plasma etching apparatus and method.

A semiconductor wafer processing apparatus may include a chuck and a focus ring. The chuck may be configured to hold a wafer. The focus ring may be disposed surrounding a rim of the chuck. The focus ring may include at least two sections made of at least two materials. At least two of the at least two materials may have different conductivities. For example, the focus ring may include a first section of a first material and a second section of a second material. The first material and the second material may have different conductivities.

One of the first and second sections may be disposed adjacent to the wafer. One of the first and second sections may be disposed above the other. The semiconductor wafer processing apparatus may also include a cover ring disposed surrounding the rim of the chuck, with the focus ring being supported in a groove between the cover ring and the chuck.

The first material may be glass carbon, silicon carbon, silicon, an oxide superconductor, a compound thereof, or the like. The second material may be quartz, a ceramic material, or the like. The first material may have a conductivity between about 2 and about 5 times higher than that of the second material. The first material may be different from the second material in surface area or volume.

The first section may be a first focus sub-ring and the second section may be a second focus sub-ring. The first focus sub-ring may be disposed surrounding the chuck, the second focus sub-ring may be disposed surrounding the first focus sub-ring, and the first material may have a conductivity higher than that of the second material.

According to an example embodiment, the first and second focus sub-rings may have an “L” shaped cross-section. The first focus sub-ring may be disposed on an inner portion of the second focus sub-ring. The first material may have a conductivity higher than that of the second material.

According to an example embodiment, the first focus sub-ring may have a rectangular cross-section and the second focus sub-ring may have an “L” shaped cross-section. The first focus sub-ring may be disposed on an inner portion of the second focus sub-ring. The first material may have a conductivity higher than that of the second material.

According to an example embodiment, the first focus sub-ring may have an “L” shaped cross-section and the second focus sub-ring may have a rectangular cross-section. The second focus sub-ring may be disposed on an outer edge of the first focus sub-ring. The first material may have a conductivity higher than that of the second material.

The focus ring may also include a ring-shaped body disposed surrounding the wafer and a coating layer disposed on a surface of the ring-shaped body. The ring-shape body may be made of one of the first and second materials and the coating layer may be made of the other one. The first material may have a conductivity higher than that of the second material. The coating layer may be coated on the entire surface or a partial surface of the ring-shaped body.

The semiconductor wafer processing apparatus may also include a chamber, a support member, and/or a shower head. The support member and the shower head may be disposed within the chamber. The support member may include the chuck and/or the focus ring. The shower head may face the support member.

A method of forming a semiconductor wafer processing apparatus may include forming a first section of a focus ring from a first material, forming a second section of the focus ring from a second material having a different conductivity than the first material, combining the first and second sections to form a focus ring, and/or arranging the focus ring so as to surround a chuck. Combining the first and second sections may include arranging one of the first and second sections above the other. Combining the first and second sections may also include arranging one of the first and second sections so as to surround the other.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a graph illustrating example etch uniformity and etch rates at various regions in a wafer for different example focus ring materials.

FIG. 2 is a schematic view illustrating an example semiconductor wafer processing apparatus according to an example embodiment.

FIGS. 3A, 3B, 4A, 4B, 5A, 5B, 6A, and 6B are schematic views illustrating example support members and example focus rings according to example embodiments.

FIG. 7 is a schematic view illustrating an example focus ring according to an example embodiment.

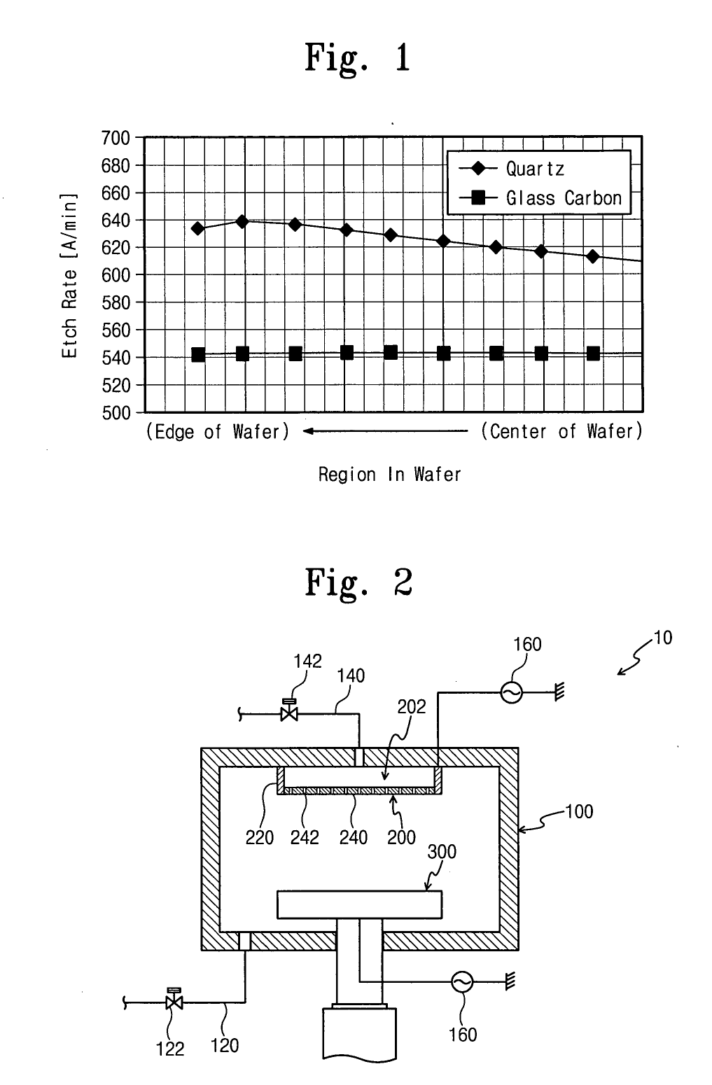

### DESCRIPTION OF EXAMPLE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

FIG. 2 is a schematic view illustrating an example semiconductor wafer processing apparatus according to an example embodiment.

Referring to FIG. 2, a semiconductor plasma apparatus 10 may include a chamber 100, a shower head 200, and/or a support member 300. The chamber 100 may receive a wafer W and provide space for performing an etching process. An exhaust pipe 120 may be connected to the bottom wall of the chamber 100 to maintain process pressure inside the chamber 100 and remove reaction byproducts. A vacuum pump (not shown) and a valve (122) may be installed on the exhaust pipe 120. Although not shown, a port may be formed on a sidewall of the chamber 100 for inserting and removing a wafer W.

A gas supply pipe 140 may be connected to the top wall of the chamber 100 to supply process gas into the chamber 100. A valve 142 may be installed on the gas supply pipe 140 to open and close the inside passage of the gas supply pipe 140 or to control the amount of process gas supplied to the chamber 100. The shower head 200 may be installed on an upper portion within the chamber 100, and may be used for scattering the gas supplied to the chamber 100 over the wafer W. For example, the shower head 200 may include a ring-shaped side plate 220 protruding downward from the top wall of the chamber 100, and a circular-shaped spray plate 240 coupled to a lower end of the side plate 220. A plurality of spray holes 242 may be formed through the spray plate 240. A buffer space 202 may be provided between the shower head 200 and the top wall of the chamber 100 for receiving the gas from the gas supply pipe 140.

The support member 300 may be disposed at a lower portion of the chamber, and the wafer W may be placed on the support member 300. The support member 300 may be disposed facing the shower head 200. Upper and lower electrodes (not shown) may be provided in the chamber 100. For example, the shower head 200 may serve as the upper electrode, and the lower electrode may be disposed in the support member 300. An oscillating power source 160 with a relatively high frequency may be connected to the upper and lower electrodes. The power source 160 may apply a relatively high frequency voltage to provide energy for generating a plasma from the process gas flowing into the chamber 100.

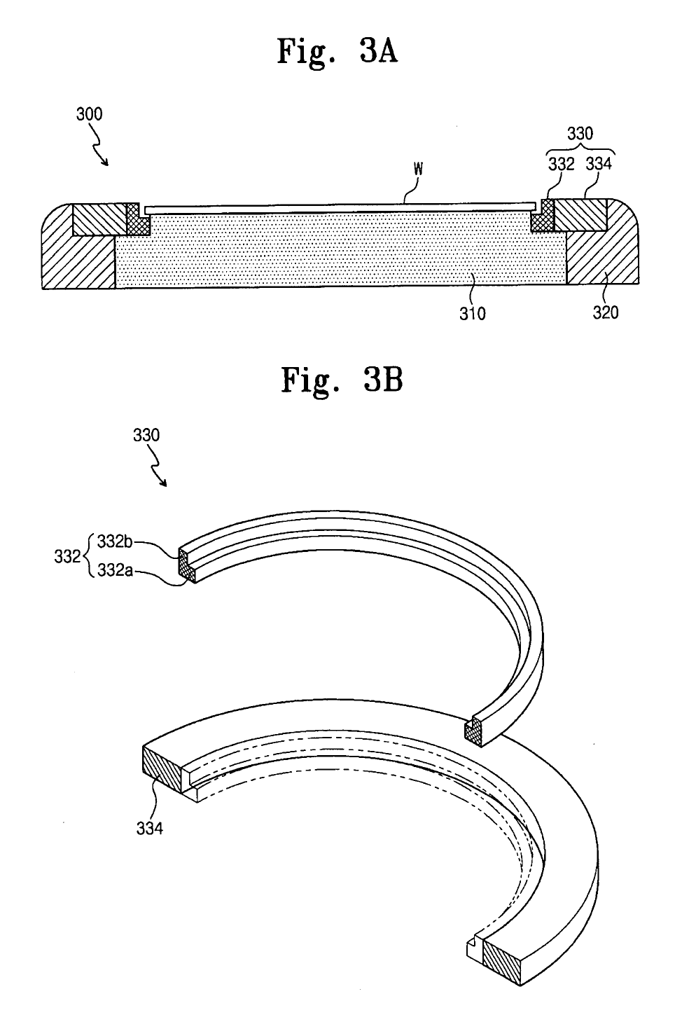

FIG. 3A is a cross-sectional view of the support member 300 illustrated in FIG. 2. FIG. 3B is an aerial view of the focus ring illustrated in FIG. 3A, according to an example embodiment.

Referring to FIGS. 3A and 3B, the support member 300 may include an electrostatic chuck 310, a cover ring 320, and/or a focus ring 330. The electrostatic chuck 310 may fix the wafer W in place using an electrostatic force. Alternatively, a vacuum chuck may be provided to adsorb the wafer W using negative pressure, instead of or in addition to the electrostatic chuck 310. The electrostatic chuck 310 may be formed in the shape of circular plate having a diameter comparable to that of the wafer W. The cover ring 320 may be ring-shaped and surround the electrostatic chuck 310. The cover ring 320 may isolate a sidewall of the electrostatic chuck 310 from the outside to reduce or prevent the exposure of the sidewall of the electrostatic chuck 310 to process gases. The cover ring 320 may also support and protect the focus ring 330. The cover ring 320 may be formed of an insulating material, for example, quartz or other materials with similar properties.

The focus ring 330 may surround the electrostatic chuck 310 and concentrate plasma on an upper portion perpendicular to the wafer W. The focus ring 330 may be disposed between the cover ring 320 and the electrostatic chuck 310.

The upper edges of the electrostatic chuck 310 may be formed at a lower position than the middle portion of the electrostatic chuck 310 where the wafer W is placed. The cover ring 320 may have an inner portion lower than an outer portion. The height of the inner portion surface of the cover ring 320 may be the same as that of the upper edge of the electrostatic chuck 310. According to the above structure, a ring-shaped groove may be formed between the electrostatic chuck 310 and the cover ring 320. The focus ring 330 may be mounted in the ring-shaped groove between the electrostatic chuck 310 and the cover ring 320.

The focus ring 330 according to an example embodiment may include a first section 332 and a second section 334, as shown in FIG. 2. Although the focus ring 330 may be described herein as including two sections, it will be understood that the focus ring 330 may include additional sections (for example, N sections where N is an integer≧2) without deviating from the scope of example embodiments. The first section 332 may be disposed adjacent to the wafer W, and the second section 334 may be disposed farther from the wafer. The first section 332 may be formed of a material with a higher conductivity than that of the second section 334.

Below, Table 1 shows example resistance values (ohm/cm) of select example materials.

TABLE 1

| | Material | | | |
|---|---|---|---|---|
| | Glass carbon | Silicon carbon | Silicon | Quartz |
| Resistance | 4.2E−03 | 2.0E−02 | 1.0E+00 | 1.0E+14 |

Referring to Table 1, glass carbon, silicon carbon, and silicon may have a relatively high conductivity compared to quartz. The first section 332 may be formed of glass carbon, silicon carbon, silicon, oxide superconductor, or compounds thereof, or other materials with similar properties. The second section 334 may be formed of quartz, ceramic materials, or the like. For example, the first section 332 may be formed of a material with a conductivity about 2 to about 5 times higher than that of the second section 334.

In the focus ring 330 according to an example embodiment, a portion adjacent to the wafer W may be formed of a material with a relatively high conductivity, and the remaining portion may be formed of a material with a relatively low conductivity. This may reduce or minimize the etch non-uniformity over various regions of the wafer W and maintain the etch rate at a sufficient level during the etching process. The reduction of the etch non-uniformity may reduce the dispersion of pattern widths formed on the wafer W, and the increased etch rate may improve the process speed and throughput.

For example, the first section 332 may be a first focus sub-ring and the second section 334 may be a second focus sub-ring, as shown in FIGS. 3A and 3B. As shown, the first focus sub-ring may have the same reference numeral as the first section, and the second focus sub-ring may have the same reference numeral as the second section. The first focus sub-ring 332 may be disposed adjacent to the wafer W, and the second focus sub-ring 334 may be disposed farther from the wafer W as compared to the first focus sub-ring 332. The first focus sub-ring 332 may be ring-shaped and spaced from the electrostatic chuck 310 by a given distance to surround the electrostatic chuck 310 and the wafer W. The first focus sub-ring 332 may include a lower body 332a facing a lower edge of the wafer W and protruding from the electrostatic chuck 310, and an upper body 332b protruding upward from an outer edge of the lower body 332a to face a side surface of the wafer W. For example, the first focus sub-ring 332 may have an “L” shaped cross-section. The second focus sub-ring 334 may be disposed surrounding the first focus sub-ring 332. The second focus sub-ring 334 may have a rectangular cross-section. Within the groove, the first focus sub-ring 332 may be disposed at an inner portion and the second focus sub-ring 334 may be disposed at an outer portion.

The first focus sub-ring 332 may be formed of a material with a higher conductivity than that of the second focus sub-ring 334. For example, the first focus sub-ring 332 may be formed of glass carbon, silicon carbon, silicon, oxide superconductor, or compounds thereof, or other materials with similar properties. The second focus sub-ring 334 may be formed of a material with a relatively low conductivity, or an insulating material. For example, the second focus sub-ring 334 may be formed of quartz, a ceramic material, or the like. The width of the first focus sub-ring 332 may be varied to control the etch uniformity and etch rate. For example, to control the etch uniformity more precisely, the first focus sub-ring 332 may have a relatively large width. Alternatively, to control the etch rate more precisely, the first focus sub-ring 332 may have a relatively small width.

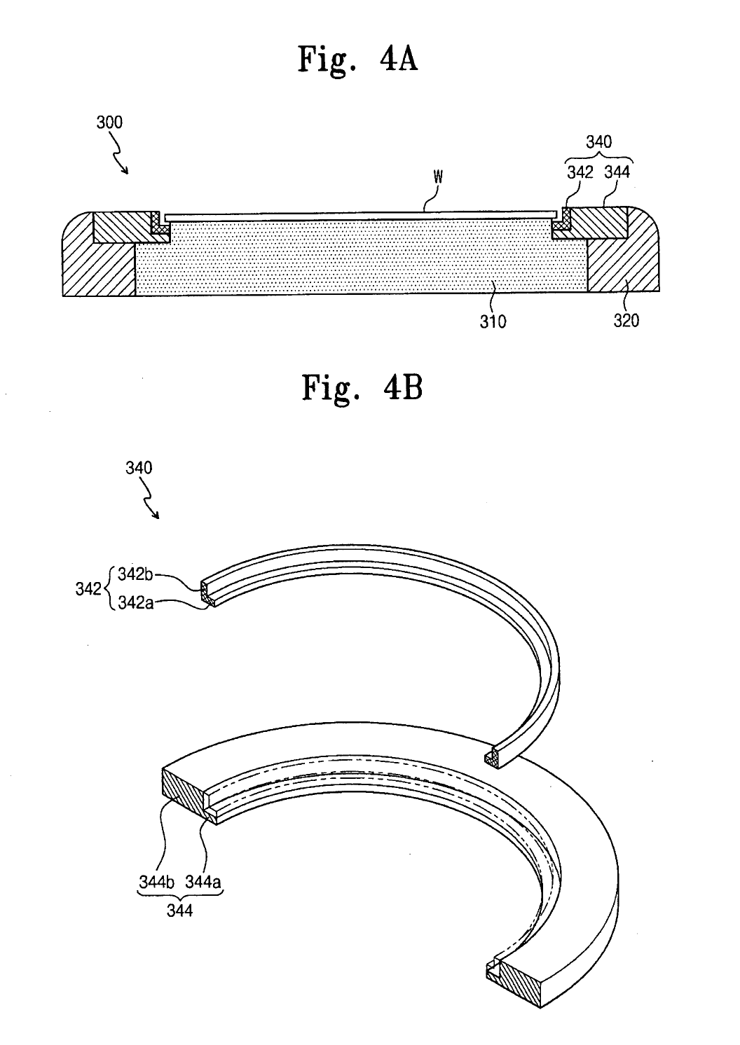

FIGS. 4A through 6A illustrate additional support members 300 and corresponding focus rings according to example embodiments.

The support members 300 of FIGS. 4A through 6A may be similar to the support member 300 of FIG. 3A with varied shapes of the focus ring. Thus, like reference numerals may denote like elements, and a description thereof may be omitted.

FIG. 4A is a cross-sectional view of an example support member 300, and FIG. 4B is an aerial view of the example focus ring 340 shown in FIG. 4A.

Referring to FIGS. 4A and 4B, the focus ring 340 may include a first focus sub-ring 342 and a second focus sub-ring 344. The first focus sub-ring 342 may include a lower body 342a that may face a lower edge of the wafer W protruding out of the electrostatic chuck 310, and an upper body 342b that may protrude upward from an outer edge of the lower body 342a and face a side surface of the wafer W. The second focus sub-ring 344 may include a lower body 344a disposed in the groove to support the first focus sub-ring 342 and an upper body 344b protruding upward from an outer edge of the upper body 344a.

For example, the first and second focus sub-rings 342 and 344 may each include an “L” shaped cross-section. The first focus sub-ring 342 may be disposed on the second focus sub-ring 344. A lower surface of the first focus sub-ring 342 may contact an upper surface of the lower body 344a of the second focus sub-ring 344, and an outer side surface of the first focus sub-ring 342 may contact an inner side surface of the upper body 344b of the second focus sub-ring 344.

In the structure of the focus ring 340 according to FIG. 4, the area or volume of the first focus sub-ring 342 with the higher conductivity may be decreased, thereby maintaining the etch rate relatively higher, compared to the focus ring 330 shown in FIG. 3.

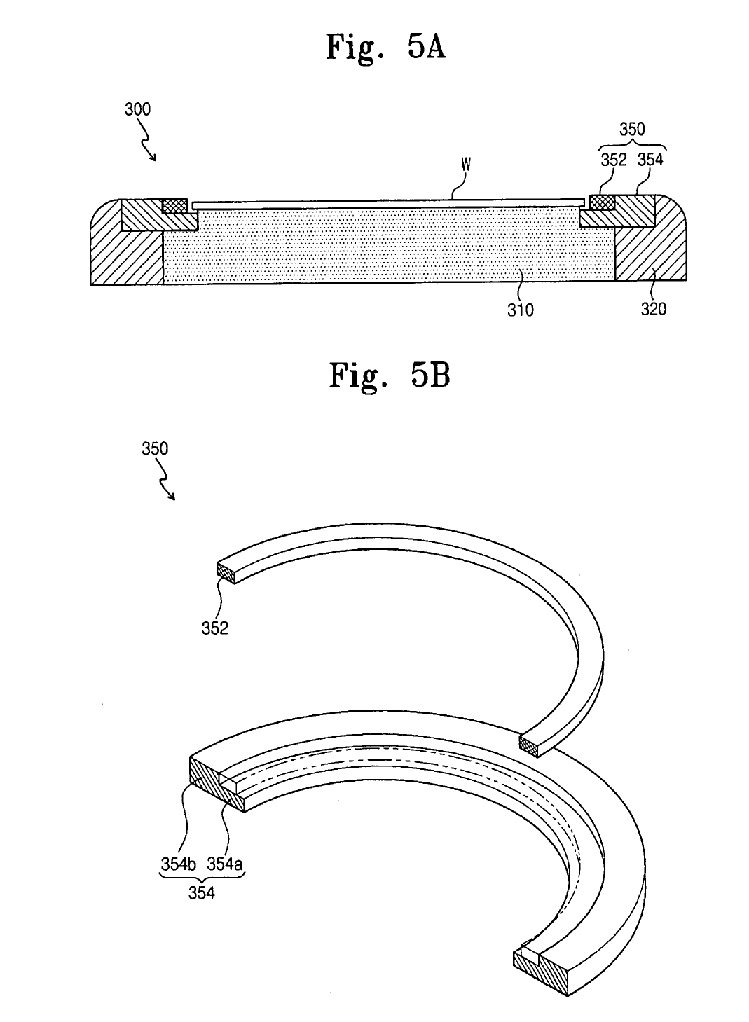

FIG. 5A is a cross-sectional view of an example support member 300, and FIG. 5B is an aerial view of the example focus ring 350 shown in FIG. 5A.

Referring to FIGS. 5A and 5B, the focus ring 350 may include a first focus sub-ring 352 and a second focus sub-ring 354. The first focus sub-ring 352 may have a rectangular cross-section, and may be disposed to face a side surface of the wafer W. The second focus sub-ring 354 may include a lower body 354a that may be disposed in the groove to support the first focus sub-ring 352, and an upper body 354b protruding upward from an outer edge of the lower body 354a. The second focus sub-ring 354 may have an “L” shaped cross-section.

In the focus ring 350 of FIG. 5, the surface area or volume of the first focus sub-ring 350 may be decreased, thereby maintaining the etch rate relatively higher as compared to the focus rings of FIGS. 3 and 4.

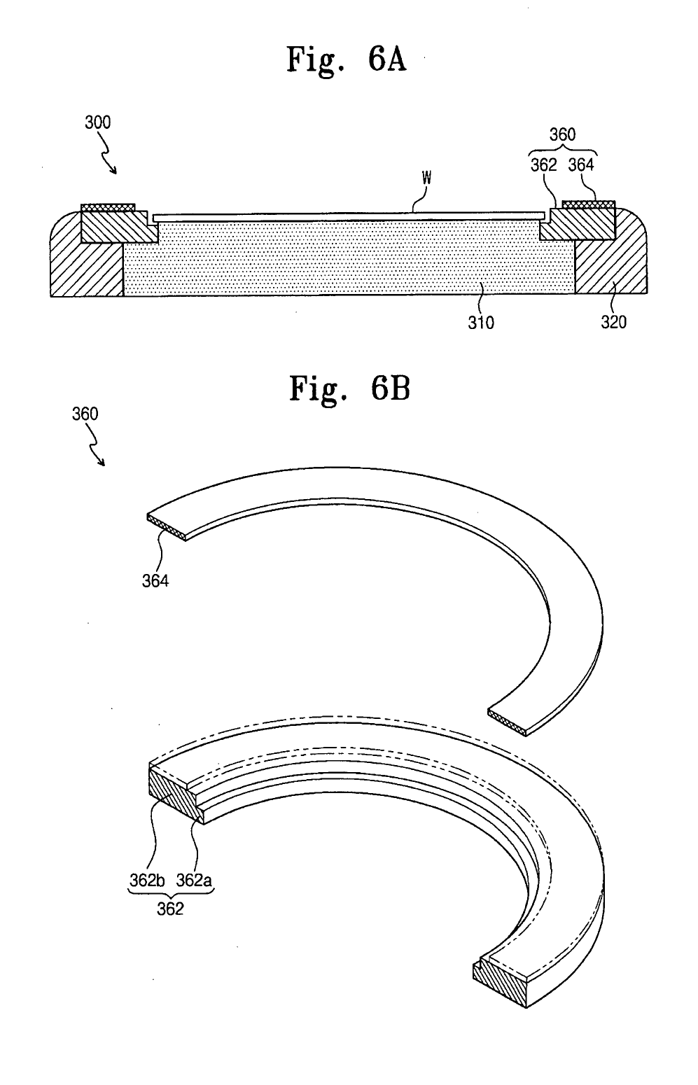

FIG. 6A is a cross-sectional view of an example support member 300, and FIG. 6B is an aerial view of the example focus ring 360 shown in FIG. 6A.

Referring to FIGS. 6A and 6B, the focus ring 360 may include a first focus sub-ring 362 and a second focus sub-ring 364. The first focus sub-ring 362 may include a lower body 362a that may face a lower edge of the wafer W protruding out of the electrostatic chuck 310, and an upper body 362b that may protrude from an outer edge of the lower body 362a to face a side surface of the wafer W. The first focus sub-ring 362 may be disposed in the groove and may have an “L” shaped cross-section. The second focus sub-ring 364 may have a rectangular cross-section and may be disposed on the upper body 362b of the first focus sub-ring 362.

In the focus ring 360 shown in FIG. 6, the area and/or volume of the first focus sub-ring 362 with the higher conductivity may be decreased, thereby maintaining the etch uniformity more precisely as compared to the focus rings shown in FIGS. 3, 4, and 5.

The first focus sub-rings 332, 342, 352 and 362 and the second focus sub-rings 334, 344, 354 and 364 may be formed and adhered using an adhesive or coupled using a coupling member, for example, bolts or the like.

According to example embodiments, the first focus sub-ring and the second focus sub-ring may be combined, or coupled to each other, in order to form the focus ring having the first and second sections formed of materials with different conductivities, as described above.

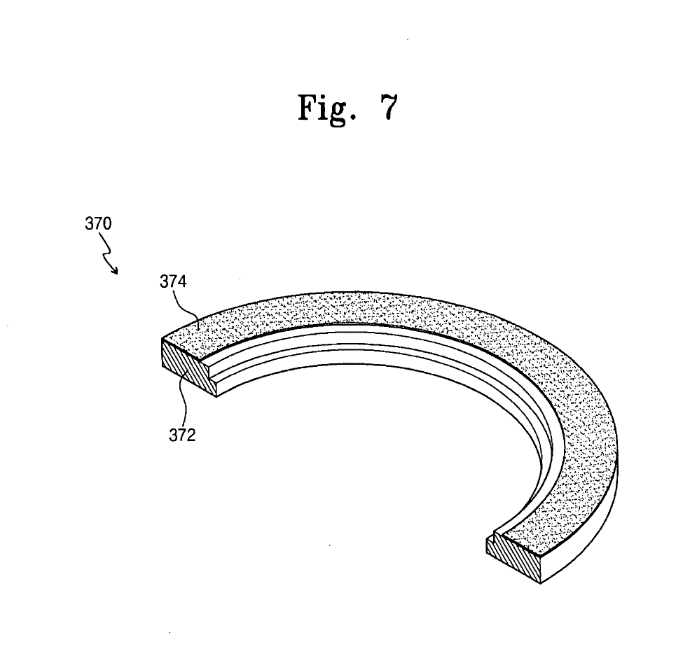

FIG. 7 illustrates a focus ring having a body and a coating layer thereon, according to an example embodiment.

According to an example embodiment, the body 372 may be formed of a material with a relatively high conductivity. For example, the body 372 may be formed of glass carbon, silicon carbon, silicon, oxide superconductor, or a compound thereof, or the like. The body 372 may be ring-shaped and may have a rectangular or “L” shaped cross-section. An upper surface of the body 372 may be coated with a material with relatively low conductivity, including insulating materials. For example, the coating layer 374 may be formed of quartz, a ceramic material, or the like. The coating layer 374 may be coated on an entire upper surface or a partial upper surface of the body 372. For example, the coating layer 374 may be spaced from the wafer W by a given distance, for example, about 3 to about 10 mm. The coating process may be performed using a spray coating or other comparable process.

According to an example embodiment, the body 372 may be formed of a material with a relatively low conductivity, including insulating materials, and the coating layer 374 may be formed of a material with a relatively high conductivity.

As described above, a semiconductor plasma apparatus according to example embodiments may be manufactured to reduce or minimize pattern dispersion in a wafer W and maintain the proper throughput.

A method of forming a semiconductor wafer processing apparatus may include forming a first section of a focus ring from a first material and/or forming a second section of the focus ring from a second material. The second material may have a different conductivity than the first material. The first and second materials may be combined to form a focus ring and the focus ring may be arranged so as to surround a chuck. Combining the first and second sections may include arranging one above the other and/or arranging one to surround the other.

Example embodiments having thus been described, it will be obvious that the same may be varied in many ways. For example, the teachings described herein may be applied to semiconductor devices for performing other plasma processes, including chemical vapor deposition and physical vapor deposition. Such variations are not to be regarded as a departure from the intended spirit and scope of example embodiments, and all such modifications as would be obvious to one skilled in the art are intended to be included within the scope of the following claims.

What is claimed is:

1. A semiconductor wafer processing apparatus, comprising:
a chuck configured to hold a wafer; and
a focus ring disposed surrounding a rim of the chuck, the focus ring including at least two sections made of at least two materials;
wherein at least two of the at least two materials have different conductivities.

2. The semiconductor wafer processing apparatus of claim 1, wherein the focus ring includes a first section of a first material and a second section of a second material, the first material and the second material having different conductivities.

3. The semiconductor wafer processing apparatus of claim 2, wherein one of the first and second sections is disposed adjacent to the wafer.

4. The semiconductor wafer processing apparatus of claim 2, wherein one of the first and second sections is disposed above the other.

5. The semiconductor wafer processing apparatus of claim 2, further comprising:
a cover ring disposed surrounding the rim of the chuck, wherein the focus ring is supported by the cover ring and the chuck in a groove therebetween.

6. The semiconductor wafer processing apparatus of claim 2, wherein the first material is one of glass carbon, silicon carbon, silicon, oxide superconductor, and a compound thereof.

7. The semiconductor wafer processing apparatus of claim 2, wherein the second material is one of quartz and a ceramic material.

8. The semiconductor wafer processing apparatus of claim 2, wherein the first material has a conductivity between about 2 and about 5 times higher than that of the second material, inclusive.

9. The semiconductor wafer processing apparatus of claim 2, wherein the first material is different from the second material in at least one of surface area or volume.

10. The semiconductor wafer processing apparatus of claim 2, wherein the first section is a first focus sub-ring and the second section is a second focus sub-ring.

11. The semiconductor wafer processing apparatus of claim 10, wherein the first focus sub-ring is disposed surrounding the chuck, the second focus sub-ring is disposed surrounding the first focus sub-ring, and the first material has a conductivity higher than that of the second material.

12. The semiconductor wafer processing apparatus of claim 10, wherein the first and second focus sub-rings have an “L” shaped cross-section, the first focus sub-ring is disposed on an inner portion of the second focus sub-ring, and the first material has a conductivity higher than that of the second material.

13. The semiconductor wafer processing apparatus of claim 10, wherein the first focus sub-ring has a rectangular cross-section, the second focus sub-ring has an “L” shaped cross-section, the first focus sub-ring is disposed on an inner portion of the second focus sub-ring, and the first material has a conductivity higher than that of the second material.

14. The semiconductor wafer processing apparatus of claim 10, wherein the first focus sub-ring has an “L” shaped cross-section, the second focus sub-ring has a rectangular cross-section, the second focus sub-ring is disposed on an outer edge of the first focus sub-ring, and the first material has a conductivity higher than that of the second material.

15. The semiconductor wafer processing apparatus of claim 2, wherein the focus ring comprises:
a ring-shaped body disposed surrounding the wafer, the ring-shape body being made of one of the first and second materials; and
a coating layer disposed on a surface of the ring-shaped body, the coating layer being made of the other one of the first and second materials,
wherein the first material has a conductivity higher than that of the second material.

16. The semiconductor wafer processing apparatus of claim 15, wherein the ring-shaped body is made of the first material, the coating layer is made of the second material, and the coating layer is disposed on the entire surface or a partial surface of the ring-shaped body.

17. The semiconductor wafer processing apparatus of claim 15, wherein the ring-shaped body is made of the second material, the coating layer is made of the first material, and the coating layer is disposed on the entire surface or a partial surface of the ring-shaped body.

18. The semiconductor wafer processing apparatus of claim 2, further comprising:
a chamber;
a support member including the chuck and the focus ring, the support member being disposed within the chamber; and
a shower head disposed within the chamber to face the support member.

19. A focus ring, comprising:
a first section of a first material; and
a second section of a second material,
wherein the first material and the second material have different conductivities.

20. A method of forming a focus ring, comprising:
forming a first section of the focus ring from a first material;
forming a second section of the focus ring from a second material having a different conductivity than the first material; and
combining the first and second sections to form the focus ring.
